(19) United States
(12) Patent Application Publication
(10) Pub. No.: US 2024/0110394 A1
(43) Pub. Date: Apr. 4, 2024

(54) Putty Knife Brush Attachment Device

(71) Applicant: Neal Quiocho, Kailua Kona, HI (US)

(72) Inventor: Neal Quiocho, Kailua Kona, HI (US)

(21) Appl. No.: 17/956,304

(22) Filed: Sep. 29, 2022

(51) Int. Cl. E04F 21/32; A46B 3/12; B25F 1/00

(52) U.S. Cl. CPC E04F 21/32; A46B 3/12; B25F 1/00

(57) ABSTRACT

A putty knife brush attachment device for attaching to a surface of a paintbrush includes a paintbrush. The base of the paintbrush has a brush side and a handle side. A grip is coupled to the handle side. The brush side is coupled to a plurality of bristles used for painting. The grip has an aperture and a peripheral surface where a knife is positioned upon. The knife has an aperture that is concentric to the aperture of the grip. A washer with a hole is positioned in between the knife and the grip to provide a space for protection of the knife. A bolt is inserted through the aperture of the knife and the aperture of the grip to fasten all the elements to each other. The knife removes glue and putty material from surfaces. The brush side is used for painting surfaces.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to putty knife utility attachments and more particularly pertains to a new putty knife utility attachment for attaching to a surface of a paintbrush.

### (2) Description of Related Art Including Information Disclosed Under 37 CFR 1.97 and 1.98

The prior art relates to putty knife utility attachments. The prior art includes a variety of putty knife utility attachments being configured for fastening to a paintbrush. Known prior art lacks a putty knife utility attachment fastening to a respective one surface of the handle of a paintbrush.

### BRIEF SUMMARY OF THE INVENTION

An embodiment of the disclosure meets the needs presented above by generally comprising a paintbrush. The paintbrush has a base. The base has a handle side and a brush side. The handle side is coupled to a grip. The grip has a distal end and a proximal end relative to the base. The distal end is a free end and has an aperture. The grip has a peripheral surface. The grip is configured for providing an area for the user to grasp the paintbrush. The brush side has a plurality of bristles. The plurality of bristles is configured for retaining paint. A knife has an edge where the edge is configured for removing putty material. The knife has a curved side. The curved side has an aperture. The aperture is configured to be concentric with the aperture of the grip of the paintbrush. The knife is configured for being positioned upon the peripheral surface of the grip of the paintbrush. A bolt has an exterior threading and has a head. The bolt is configured for anchoring the knife to the paintbrush. A nut has an aperture. The aperture of the nut is circular and has internal threading. The internal threading of the nut is complementary to the threading of the bolt. The nut is configured for engaging by threading to the bolt.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a putty knife brush attachment device according to an embodiment of the disclosure.

FIG. 2 is an isometric exploded view of an embodiment of the disclosure.

FIG. 3 is a front view of an embodiment of the disclosure.

FIG. 4 is a back view of an embodiment of the disclosure.

FIG. 5 is an alternative view of an embodiment of the disclosure.

FIG. 6 is an alternative view of an embodiment of the disclosure.

### DETAILED DESCRIPTION OF THE INVENTION

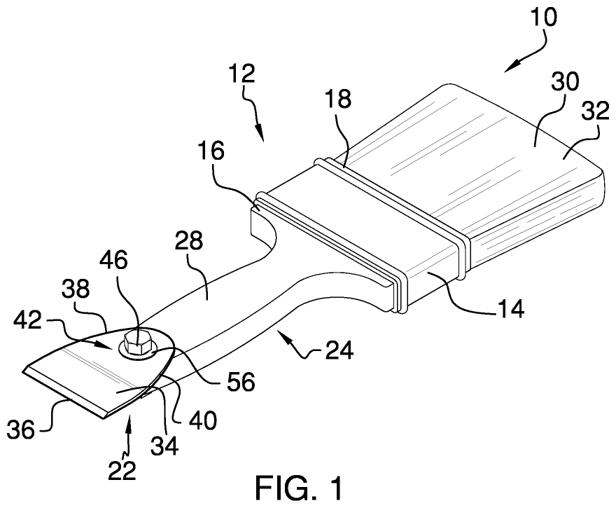

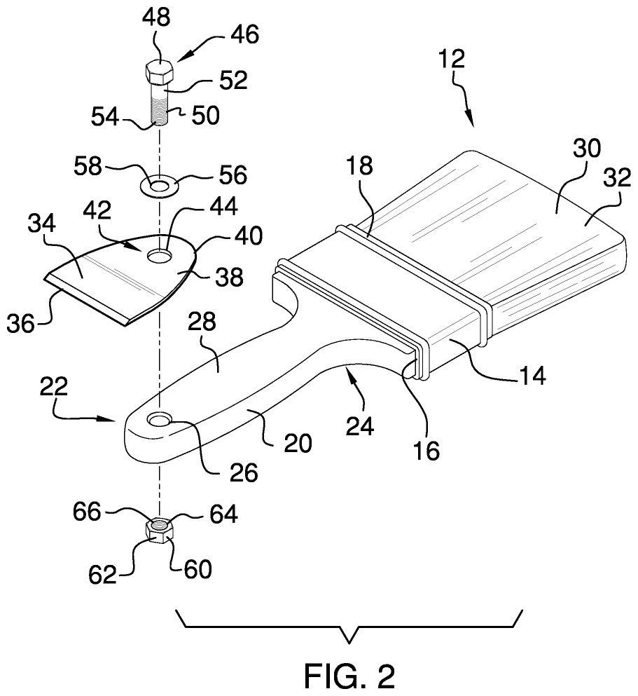

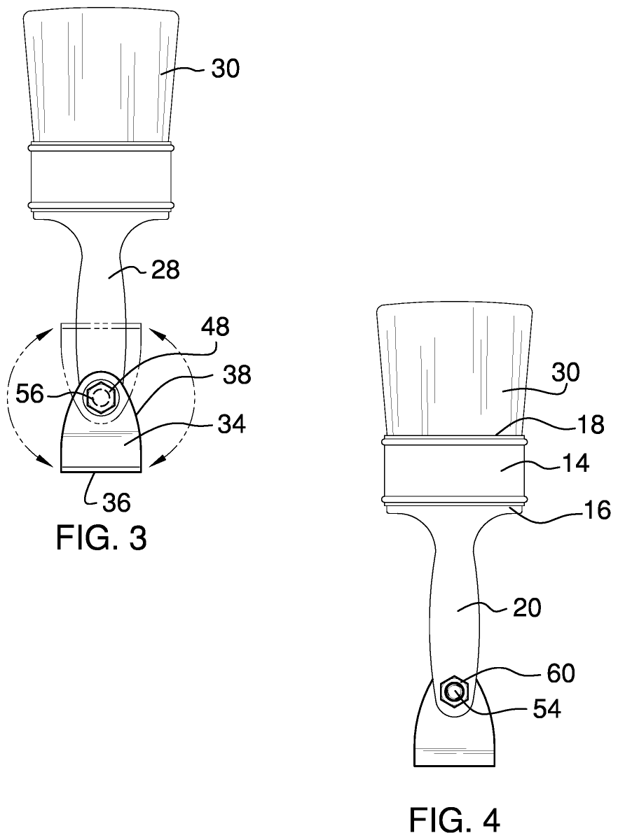

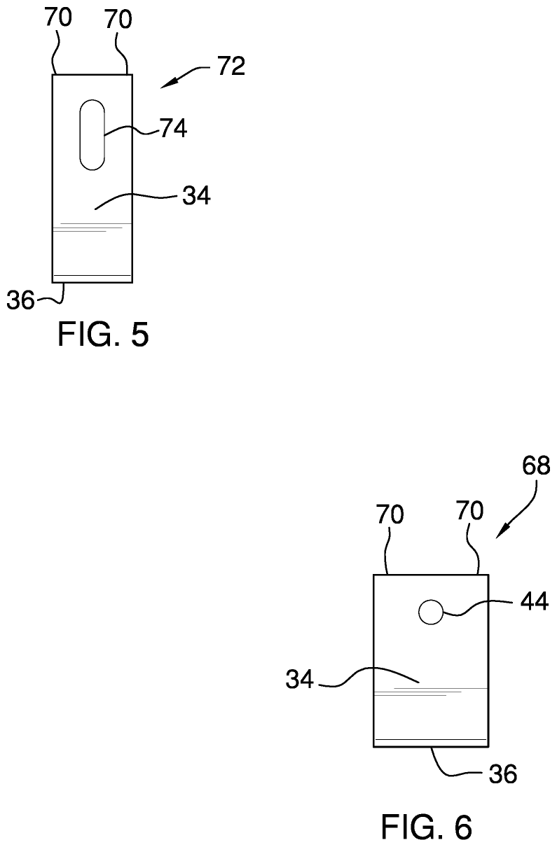

With reference now to the drawings, and in particular to FIGS. 1 through 6 thereof, a new putty knife utility attachment embodying the principles and concepts of an embodiment of the disclosure and generally designated by the reference numeral 10 will be described.

As best illustrated in FIGS. 1 through 6, the putty knife brush attachment device generally comprises a paintbrush 12. The paintbrush 12 has a base 14 being a rectangular prism shape. The base 14 has a handle side 16 and a brush side 18. The handle side 16 and the brush side 18 are parallel to one another. The handle side 16 is coupled to a grip 20. The grip 20 has a distal end 22 and a proximal end 24 relative to the base 14. The proximal end 24 is coupled to the handle side 16 of the base 14, whereby the distal end 22 is a free end. The distal end 22 has an aperture 26 and the aperture 26 of the grip 20 is circular.

Furthermore, the grip 20 has a peripheral surface 28 that is configured for providing an area for a variety of elements to be positioned upon. The purpose of the grip 20 is to provide a structure for the user to grasp the paintbrush 12. The brush side 18 of the base 14 has a plurality of bristles 30. Each of the bristles 30 is coupled to the brush side 18 and protrudes outward from therefrom. Each of the bristles 30 is a plastic material 32, such as nylon. The plurality of bristles 30 is configured for retaining liquid paint around each of the bristles 30.

A knife 34 is positioned upon the peripheral surface 28 of the grip 20 of the paintbrush 12. The knife 34 has an edge 36 being sharpened. The edge 36 of the knife 34 is positioned facing away from the base 14 of the paintbrush 12. The edge 36 of the knife 34 is configured for removing putty material, where the putty material can be glue. Additionally, the knife 34 has a curved side 38. The curved side 38 of the knife 34 is a semi-oval shape 40. In a center 42 of the semi-oval shape 40 is an aperture 44. The aperture 44 of the knife 34 is circular and is configured to be positioned concentric relative to the aperture 26 of the grip 20 of the paintbrush 12.

A bolt 46 with a head 48 has an exterior threading 50 on its outer surface 52. The bolt 46 has an end 54 which is flat. The bolt 46 can be inserted into both the aperture 44 of the knife 34 and the aperture 26 of the paintbrush 12. The bolt 46 is configured for anchoring the knife 34 to the peripheral surface 28 of the paintbrush 12. A washer 56 is positioned between the knife 34 and the head 48 of the bolt 46. The washer 56 is circular and has a hole 58. The hole 58 is configured to enwrap the outer surface 52 of the bolt 46. The washer 56 is configured to provide a space between the knife 34 and the head 48 of the bolt 46 to reduce surface damage to the knife 34 when tightening the bolt 46.

A nut 60 has a hexagon shape 62 which is configured to be used by a utility wrench. The nut 60 has an aperture 64 which is circular and has an internal threading 66. The internal threading 66 of the nut 60 is complementary to the exterior threading 50 of the bolt 46. The nut 60 is configured to engage by threading to the bolt 46 and helps in retaining the knife 34 in a fixed position upon the peripheral surface 28 of the paintbrush 12.

An alternative embodiment of the putty knife brush attachment device 10 includes variations to the knife 34. A first variation 68 of the knife 34 includes the curved side 38 of the knife 34 lacking the semi-oval shape 40 and instead having a pair of corners 70 whereby producing a rectangular shape of the knife 34. A second variation 72 of the knife 34 includes the first variation 68 of the knife 34 with the aperture 44 of the knife 34 being an oval shape 74 and lacking being circular. The oval shape 74 of the aperture 44 of the second variation 72 is configured for adjusting the positioning of the knife 34 along the grip 20 of the paintbrush 12.

In use, the aperture 44 of the knife 34 is positioned upon the peripheral surface 28 of the grip 20 of the paintbrush 12. The aperture 44 of the knife 34 is to be aligned concentric to the aperture 26 of the grip 20 of the paintbrush 12. The washer 56 is positioned upon the knife 34 where the hole 58 of the washer 56 is concentric to the aperture 44 of the knife 34. The end 54 of the bolt 46 is inserted into the hole 58 of the washer 56 and out through the aperture 26 of the grip 20 of the paintbrush 12. The head 48 of the bolt 46 will restrain the bolt 46 from further insertion. The nut 60 is threadedly engaged proximate to the end 54 of the bolt 46 whereby fastening all of the mentioned elements together in a fixed position.

The user can grasp the paintbrush 12 by the grip 20 when in use. The brush side 18 of the paint brush 12 can be used for painting a variety of surfaces using liquid paint. The knife 34 can be used to remove a variety of items including glue, putty material, or any tacky material. When the knife 34 is no longer needed, the user can unfastened the nut 60 from the bolt 46 and extract the bolt 46 to unfasten the elements from one another.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A putty knife brush attachment device comprising:
a paintbrush, said paintbrush comprising:
a base, said base having a handle side and a brush side;
a grip, said grip being coupled to and extending from said handle side, said grip have a distal end and a proximal end relative to the base, said distal end being a free end, said distal end having an aperture, said grip having a peripheral surface, said grip being configured for providing an area for the user to grasp said paintbrush; and
a plurality of bristles, said plurality of bristles being coupled to and extending from said brush side, said plurality of bristles being configured for retaining paint;
a knife, said knife having an edge, said edge being configured for removing putty material, said knife having a curved side, said curved side having an aperture, said aperture being configured to be concentric with said aperture of said grip of said paintbrush, said knife being configured for being positioned upon said peripheral surface of said grip of said paintbrush;
a bolt, said bolt having an exterior threading, said bolt having a head, said bolt being configured for anchoring said knife to said paintbrush; and
a nut, said nut having an aperture, said aperture being circular and having an internal threading, said internal threading of said nut being complementary to said threading of said bolt, said nut being configured for engaging by threading to said bolt.

2. The putty knife brush attachment device of claim 1, further comprising said base being a rectangular prism shape.

3. The putty knife brush attachment device of claim 1, further comprising said handle side and said brush side being parallel to each other.

4. The putty knife brush attachment device of claim 1, further comprising said aperture of said grip being circular.

5. The putty knife brush attachment device of claim 1, further comprising said proximal end of said grip being coupled to said handle side of said base.

6. The putty knife brush attachment device of claim 1, further comprising each of said bristles being a plastic material such as nylon.

7. The putty knife brush attachment device of claim 1, further comprising said edge of said knife being sharpened, said edge being configured for removing a putty material.

8. The putty knife brush attachment device of claim 1, further comprising said curved side having a semi-oval shape.

9. The putty knife brush attachment device of claim 1, further comprising said aperture of said knife being circular.

10. The putty knife brush attachment device of claim 1, further comprising said bolt having an end, said end of said bolt being flat.

11. The putty knife brush attachment device of claim 1, further comprising a washer, said washer having a circular shape, said washer having a hole, said hold defining a space for said bolt to be inserted within, said washer being configured for being positioned concentric between said head of said bolt and said knife.

12. The putty knife brush attachment device of claim 1, further comprising said nut having a hexagon shape.

13. The putty knife brush attachment device of claim 1, further comprising an alternative embodiment, said alternative embodiment being said curved side of said knife having a pair of corners whereby being a square shape, said aperture of said knife being oval shaped.

14. A putty knife brush attachment device comprising:
a paintbrush, said paintbrush comprising:
a base, said base being a rectangular prism shape, said base having a handle side and a brush side, said handle side and said brush side being parallel to each other;
a grip, said grip being coupled to and extending from said handle side, said grip have a distal end and a proximal end relative to the base, said distal end being a free end, said distal end having an aperture, said aperture of said grip being circular, said proximal end of said grip being coupled to said handle side of said base, said grip having a peripheral surface, said grip being configured for providing an area for the user to grasp said paintbrush; and
a plurality of bristles, said plurality of bristles being coupled to and extending from said brush side, each of said bristles being a plastic material such as nylon, said plurality of bristles being configured for retaining paint;
a knife, said knife having an edge, said edge of said knife being sharpened, said edge being configured for removing a putty material, said knife having a curved side, said curved side having a semi-oval shape, said curved side having an aperture, said aperture of said knife being circular, said aperture of said knife being configured to be concentric with said aperture of said grip of said paintbrush, said knife being configured for being positioned upon said peripheral surface of said grip of said paintbrush;
a bolt, said bolt having an exterior threading, said bolt having an end, said end of said bolt being flat, said bolt having a head, said bolt being configured for anchoring said knife to said paintbrush;
a washer, said washer having a circular shape, said washer having a hole, said hold defining a space for said bolt to be inserted within, said washer being configured for being positioned concentric between said head of said bolt and said knife;
a nut, said nut having a hexagon shape, said nut having an aperture, said aperture being circular and having an internal threading, said internal threading of said nut being complementary to said threading of said bolt, said nut being configured for engaging by threading to said bolt; and
an alternative embodiment, said alternative embodiment being said curved side of said knife having a pair of corners whereby being a square shape, said aperture of said knife being oval shaped.
